(19) United States
(12) Patent Application Publication
(10) Pub. No.: US 2022/0138451 A1
(43) Pub. Date: May 5, 2022

(54) SYSTEM AND METHOD FOR IMPORTANCE RANKING FOR COLLECTIONS OF TOP-DOWN AND TERRESTRIAL IMAGES

(71) Applicant: HERE Global B.V., Eindhoven (NL)

(72) Inventors: David Lawlor, Evanston, IL (US); Zhanwei Chen, Eindhoven (NL)

(21) Appl. No.: 17/085,936

(22) Filed: Oct. 30, 2020

(51) Int. Cl. G06K 9/00; G06T 7/00; G06T 7/70

(52) U.S. Cl. CPC G06K 9/0063; G06T 7/0002; G06T 2207/30168; G06T 7/70; G06T 2207/10032; G06T 7/97

(57) ABSTRACT

A method includes obtaining an object comprising a plurality of images, each image comprising at least one of: one or more tie points or one or more stray points. The method also includes determining an importance score of each tie point of the one or more tie points in the images. The method also includes determining an importance score of each stray point of the one or more stray points in the images. The method also includes determining an importance score of the object based on the importance score of the one or more tie points and the importance score of the one or more stray points. The method also includes providing the importance score of the object as an output for selection of the object for image labeling.

### TECHNICAL FIELD

This disclosure is generally directed to image processing. More specifically, this disclosure is directed to a system and method for importance ranking for collections of top-down and terrestrial images.

### BACKGROUND

With advanced, efficient, and cost-effective remote sensing and terrestrial acquisition systems, and increased numbers of satellites in orbit and increased size of terrestrial capture fleets, the amount of top-down and terrestrial capture data has increased dramatically over the past several years. This capture data can be used for generating accurate, up-to-date, high resolution maps. However, the large amount of data can make filtering and sorting of the data a time-intensive challenge.

### SUMMARY

This disclosure relates to a system and method for importance ranking for collections of top-down and terrestrial images.

In a first embodiment, a method includes obtaining an object comprising a plurality of images, each image comprising at least one of: one or more tie points or one or more stray points. The method also includes determining an importance score of each tie point of the one or more tie points in the images. The method also includes determining an importance score of each stray point of the one or more stray points in the images. The method also includes determining an importance score of the object based on the importance score of the one or more tie points and the importance score of the one or more stray points. The method also includes providing the importance score of the object as an output for selection of the object for image labeling.

In a second embodiment, a system includes at least one memory configured to store instructions and at least one processor coupled to the at least one memory. The at least one processor is configured when executing the instructions to obtain an object comprising a plurality of images, each image comprising at least one of: one or more tie points or one or more stray points. The at least one processor is also configured when executing the instructions to determine an importance score of each tie point of the one or more tie points in the images. The at least one processor is also configured when executing the instructions to determine an importance score of each stray point of the one or more stray points in the images. The at least one processor is also configured when executing the instructions to determine an importance score of the object based on the importance score of the one or more tie points and the importance score of the one or more stray points. The at least one processor is also configured when executing the instructions to provide the importance score of the object as an output for selection of the object for image labeling.

In a third embodiment, a non-transitory computer readable medium contains instructions that when executed cause at least one processor to obtain an object comprising a plurality of images, each image comprising at least one of: one or more tie points or one or more stray points; determine an importance score of each tie point of the one or more tie points in the images; determine an importance score of each stray point of the one or more stray points in the images; determine an importance score of the object based on the importance score of the one or more tie points and the importance score of the one or more stray points; and provide the importance score of the object as an output for selection of the object for image labeling.

Other technical features may be readily apparent to one skilled in the art from the following figures, descriptions, and claims.

### BRIEF DESCRIPTION OF THE DRAWINGS

For a more complete understanding, reference is now made to the following description taken in conjunction with the accompanying drawings in which:

FIG. 1 illustrates an example system for use in importance ranking for collections of top-down and terrestrial images according to this disclosure;

FIG. 2 illustrates an example device for use in importance ranking for collections of top-down and terrestrial images according to this disclosure;

FIG. 3 illustrates an example process for estimating the importance of collections of top-down and terrestrial images according to this disclosure;

FIG. 4 illustrates an example environment in which terrestrial images are captured and feature points are detected according to this disclosure; and

FIG. 5 illustrates an example method for importance ranking for collections of top-down and terrestrial images according to this disclosure.

### DETAILED DESCRIPTION

Referring now to the drawings, wherein like reference numbers are used herein to designate like elements throughout, the various views and embodiments of a system and method for importance ranking for collections of top-down and terrestrial images are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

As discussed above, the amount of top-down and terrestrial capture data has increased dramatically over the past several years. Given the amount of data to sift through and geospatial extent of each top-down image, intelligent task-based sorting of top-down and terrestrial images has great potential.

Top-down images, such as those obtained via satellite, can cover vast swaths of areas, and can be used for the derivation of different kinds of features on the earth surface at a city scale. Similarly, terrestrial capture imagery from a fleet of vehicles can cover large areas and can also be used for feature derivation at scale. For instance, ground control points (GCPs) are one useful feature. GCPs are defined as precise points on the earth's surface where the exact location (i.e., latitude, longitude, and elevation) is known. Painted line intersections on roadways are an ideal feature type to be used as a GCP, since they are typically visible in both top-down/satellite and terrestrial imagery. Painted line intersections are defined as the intersection of two curvilinear painted line markings on a roadway, which are not part of a repeated/patterned area of paint.

These GCPs are most useful if they are tied to imagery from both top-down and terrestrial sources. In this case, the GCPs provide a link between the positioning accuracy of the two sensor modalities. For instance, if the top-down imagery is known to be of high accuracy, GCP coordinates derived from the top-down imagery can be used as a control to adjust the positioning of the terrestrial source to which the same GCP is tied. Similarly, if the terrestrial source is known to be of high accuracy, GCP coordinates derived from the terrestrial imagery can be used as a control to adjust the positioning of the top-down source to which the same GCP is tied.

The GCPs are very useful in creating accurate, up-to-date, high-resolution maps. Maps in the form of models of the environment can be used in a wide range of automated applications including driving, transportation, guidance, and search and rescue. Such applications rely on high mapping accuracy. Likewise, GCPs are important for geospatially correcting a range of other data sources (e.g. aerial/satellite imagery, GPS/GNSS position from terrestrial capture vehicles, etc.)

Traditionally, GCPs can be used to correct top-down images. For example, surveyors can go out in the field and use instruments like theodolite, measuring tapes, 3D scanners, GPS/GNSS, level and rod, and the like, to measure the location of distinguishable landmarks on the earth (e.g., parts of signs, barriers, buildings, road paint, and the like). Collecting each GCP requires a substantial amount of infrastructure, and the problem becomes even more pronounced if the GCP is to be measured on the road (e.g., for map making use cases), since special access permissions may need to be obtained from the government or another managing entity. The collection may be performed without understanding of which regions and feature points would be visible from the top-down images collected in the area that needs to be mapped.

Alternately, the GCPs can be obtained from another high-fidelity source that observes them. For instance, GCPs can be marked by human labelers in multiple terrestrial images that are determined to be of high position quality. Using the markings and triangulation techniques, the GCPs can be obtained. However, both of the above processes are time and money intensive. Thus, it of great value to select in advance which points need to be collected or marked in the high-fidelity source, in order to make the best use of the labeler's time.

To address these and other issues, the embodiments disclosed herein provide systems and methods for importance ranking for collections of top-down and terrestrial images. Some of the disclosed embodiments rank collections of top-down image crops and terrestrial captures in the same geographical area so as to maximize the likelihood that a feature of interest is visible in both top-down and terrestrial views. While some of the disclosed embodiments are described in the context of roadway markings, it will be understood that the principles described herein can be applied in other scenarios.

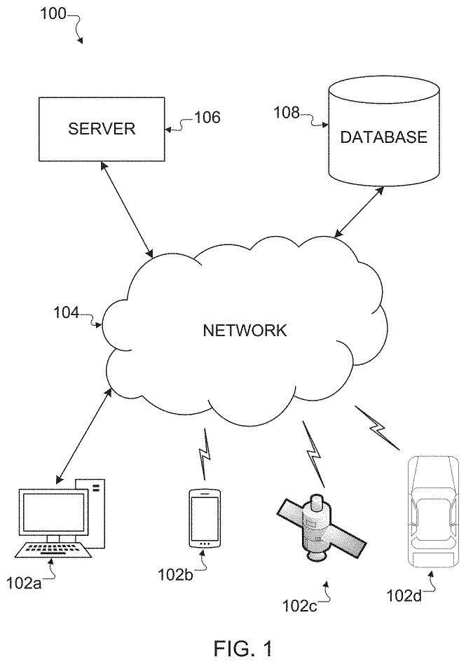

FIG. 1 illustrates an example system 100 for use in importance ranking for collections of top-down and terrestrial images according to this disclosure. As shown in FIG. 1, the system 100 includes multiple computing devices 102a-102d, at least one network 104, at least one server 106, and at least one database 108. Note, however, that other combinations and arrangements of components may also be used here.

In this example, each computing device 102a-102d is coupled to or communicates over the network 104. Communications between or involving each computing device 102a-102d and the network 104 may occur in any suitable manner, such as via a wired or wireless connection. Each computing device 102a-102d represents any suitable device or system capable of providing information to the server 106 or database 108 or to receive information from the server 106 or database 108. Example types of information may include image data, image metadata, feature points, importance scores, and the like. Any suitable number(s) and type(s) of computing devices 102a-102d may be used in the system 100. In this particular example, the computing device 102a represents a desktop computer, the computing device 102b represents a smartphone computer, the computing device 102c represents one or more sensing devices (e.g., cameras, location sensors, and the like) and computing devices onboard a satellite vehicle or aerial vehicle, and the computing device 102d represents one or more sensing devices (e.g., cameras, location sensors, and the like) onboard a terrestrial vehicle (e.g., an automobile). However, any other or additional types of computing devices may be used in the system 100, such as position sensors, other types of sensors, and the like. Each computing device 102a-102d includes any suitable structure configured to transmit and/or receive information.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The server 106 is coupled to the network 104 and is coupled to or otherwise communicates with the database 108. The server 106 supports the retrieval of information from the database 108 and the processing of that information. Of course, the database 108 may also be used within the server 106 to store information, in which case the server 106 may store the information itself. Among other things, the server 106 processes information for use in importance ranking for collections of top-down and terrestrial images. The server 106 includes any suitable structure configured to process information for use in importance ranking for collections of top-down and terrestrial images. In some embodiments, the server 106 includes one or more processors, one or more memories, and one or more communication interfaces. Note, however, that the server 106 may be implemented in any suitable manner to perform the described functions. Also note that while described as a server here, the device(s) actually implementing the server 106 may represent one or more desktop computers, laptop computers, server computers, or other computing or data processing devices or systems.

The database 108 stores various information used, generated, or collected by the server 106 and the computing devices 102a-102d. For example, the database 108 may store image data, image metadata, feature points, importance scores, and the like. The database 108 may support any suitable technique for storing and retrieving information.

Note that there are a number of possible ways to implement the system 100 in order to provide the described functionality for importance ranking for collections of top-down and terrestrial images. For example, in some embodiments, the server 106 and database 108 are owned, operated, or managed by a common entity. In other embodiments, the server 106 and database 108 are owned, operated, or managed by different entities. However, this disclosure is not limited to any particular organizational implementation.

Although FIG. 1 illustrates one example of a system 100 for use in importance ranking for collections of top-down and terrestrial images, various changes may be made to FIG. 1. For example, the system 100 may include any number of computing devices 102a-102d, networks 104, servers 106, and databases 108. Also, while FIG. 1 illustrates that one database 108 is coupled to the network 104, any number of databases 108 may reside at any location or locations accessible by the server 106, and each database 108 may be coupled directly or indirectly to the server 106. In addition, while FIG. 1 illustrates one example operational environment for use in importance ranking for collections of top-down and terrestrial images, this functionality may be used in any other suitable system.

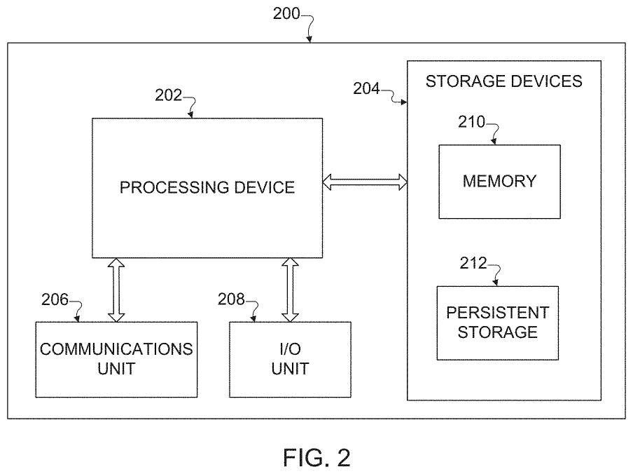

FIG. 2 illustrates an example device 200 for use in importance ranking for collections of top-down and terrestrial images according to this disclosure. One or more instances of the device 200 may, for example, be used to at least partially implement the functionality of the server 106 of FIG. 1. However, the functionality of the server 106 may be implemented in any other suitable manner. Also, the same or similar arrangement of components may be used to at least partially implement the functionality of one or more of the computing devices 102a-102d in FIG. 1. However, the functionality of each computing device 102a-102d may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 can be accessed remotely.

In some embodiments, the instructions executed by the processing device 202 can include instructions that implement the functionality of the server 106 described above. For example, the instructions executed by the processing device 202 can include instructions for importance ranking for collections of top-down and terrestrial images.

Although FIG. 2 illustrates one example of a device 200 for use in importance ranking for collections of top-down and terrestrial images, various changes may be made to FIG. 2. For example, computing devices and systems come in a wide variety of configurations, and FIG. 2 does not limit this disclosure to any particular computing device or system.

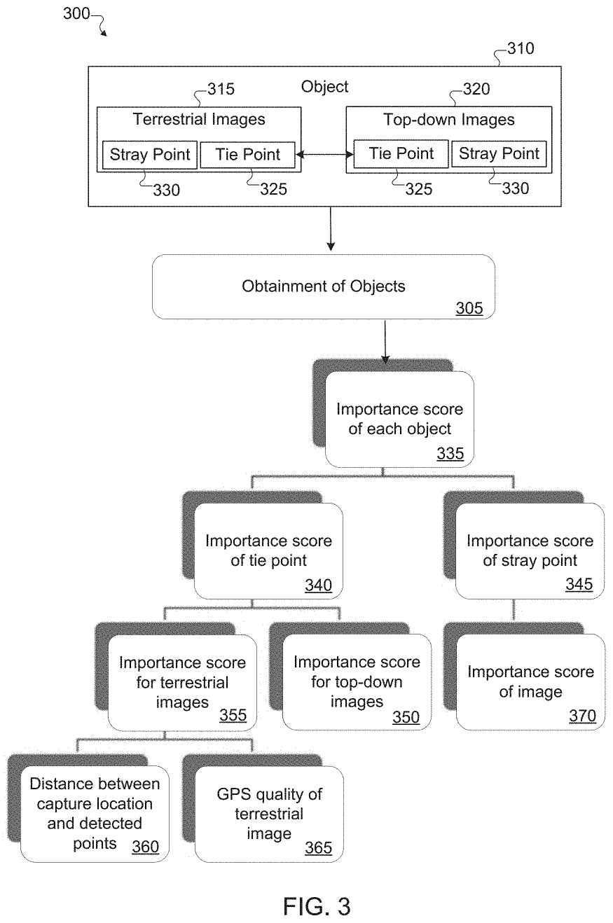

FIG. 3 illustrates an example process 300 for estimating the importance of collections of top-down and terrestrial images according to this disclosure. For ease of explanation, the process 300 of FIG. 3 may be described as involving the use of one or more components of FIG. 1 or FIG. 2. However, the process 300 may involve the use of any suitable device(s) in any suitable system(s).

As shown in FIG. 3, the process 300 includes an object obtainment operation 305. In the object obtainment operation 305, multiple “objects” 310 are obtained. As used herein, an “object” 310 refers to a collection of terrestrial images 315 and top-down images 320 that generally show the same geographic area of interest. Each terrestrial image 315 is captured using a terrestrial camera, such as a camera mounted in or on a ground-based vehicle. In some embodiments, each terrestrial image 315 is a street view image that is captured using a camera of a vehicle, while the vehicle traverses streets and roadways. Each top-down image 320 is captured using a camera that is mounted in or on a satellite, drone, aircraft, or the like. Each image 315, 320 includes one or more feature points (i.e., images of physical features) that can be identified and labeled. In some embodiments, each feature point is a road marking, such as a painted line intersection or a road sign. In other embodiments, a feature point can refer to other types of geographical or physical features.

Once the objects 310 are obtained, the objects 310 can be stored together or otherwise stored in a commonly accessible location. In some embodiments, the objects 310 can be stored in a database, such as the database 108. Each object 310 can be obtained and stored using any suitable method. For example, some objects 310 can be automatically obtained using one or more automated feature point detectors or automated corresponders that process large numbers of electronically stored images.

As discussed above, different images can represent different levels of accuracy, and images with higher accuracy can be used as controls for adjusting sources of less accurate images. In the case of terrestrial images 315, it is preferable for the detected feature points to be close in proximity to the terrestrial source (e.g., camera), as the positioning accuracy of the terrestrial source decreases with distance between the detected point and the capture vehicle. In order for one source to be used as a control for another source, detected feature points must be visible in at least one image from both sources. Such feature points that correspond across two or more images are known as “tie points” 325. For example, as shown in FIG. 3, a tie point 325 of at least one terrestrial image 315 corresponds to a tie point 325 of at least one top-down image 320. Other tie points 325 can correspond between two or more terrestrial images 315 or between two or more top-down images 320.

In addition to tie points 325, each image 315, 320 can include one or more “stray points” 330. A stray point 330 is a feature point that is detected in one image 315, 320, but does not correspond to any other image 315, 320. Stray points 330 can be useful as training data for training feature point detectors, other machine learning algorithms, and the like.

Once the objects 310 are obtained at operation 305, an importance score of each object 310 can be determined at operation 335. The importance score of each object 310 is determined based on an importance score of each tie point 325 in the object 310 and an importance score of each stray point 330 in the object 310. The importance score of each tie point 325 in the object 310 can be determined at operation 340. Similarly, the importance score of each stray point 330 in the object 310 can be determined at operation 345. These processes will be described in greater detail below. In some embodiments, the importance score of an object 310 can be determined by summing the importance scores of all tie points 325 and stray points 330 in the object 310 and assigning the resulting sum as the importance score of the object 310. In some embodiments, the importance score of the object 310 can be determined using a modified summation function that includes one or more weightings. In some embodiments, the importance score of the object 310 can be determined using another mathematical function (e.g., averaging) or algorithm.

As indicated above, the importance score of each tie point 325 in the object 310 can be determined at operation 340. At operation 340, the importance score of each tie point 325 in the object 310 can be determined based on (i) an importance score for top-down images 320 in the object 310 where the tie point 325 is visible, and (ii) an importance score for terrestrial images 315 where the tie point 325 is visible. These importance scores are determined at operations 350 and 355, respectively, as shown in FIG. 3 and described below.

At operation 350, the importance score for the top-down images 320 where the tie point 325 is visible is assigned based on an estimated overall importance of the top-down images 320. In some embodiments, the importance score can be a constant value, where more top-down images 320 with tie point correspondences increase the importance score. As a particular example, the importance score can be simply a scalar value indicating how many of the top-down images 320 in which the tie point 325 is visible. For example, if the tie point 325 is visible in two top-down images 320, then the importance score for the top-down images 320 is 2. In other embodiments, the importance score can be based on a function that takes into account metadata of the top-down image 320, such as positional accuracy, ground sampling distance, and the like. For example, some satellite or aerial cameras have higher resolution capabilities, which may result in a better top-down image 320, and thus a higher importance score of the tie point 325.

At operation 355, the importance score for the terrestrial images 315 where the tie point 325 is visible is assigned based on an estimated importance of each terrestrial image 315. The importance of each terrestrial image 315 can be estimated based on (i) an estimated distance between the capture location and detected feature points of the terrestrial image 315 (as determined at operation 360), (ii) a GPS quality of the terrestrial image 315 (as determined at operation 365), or a combination of these.

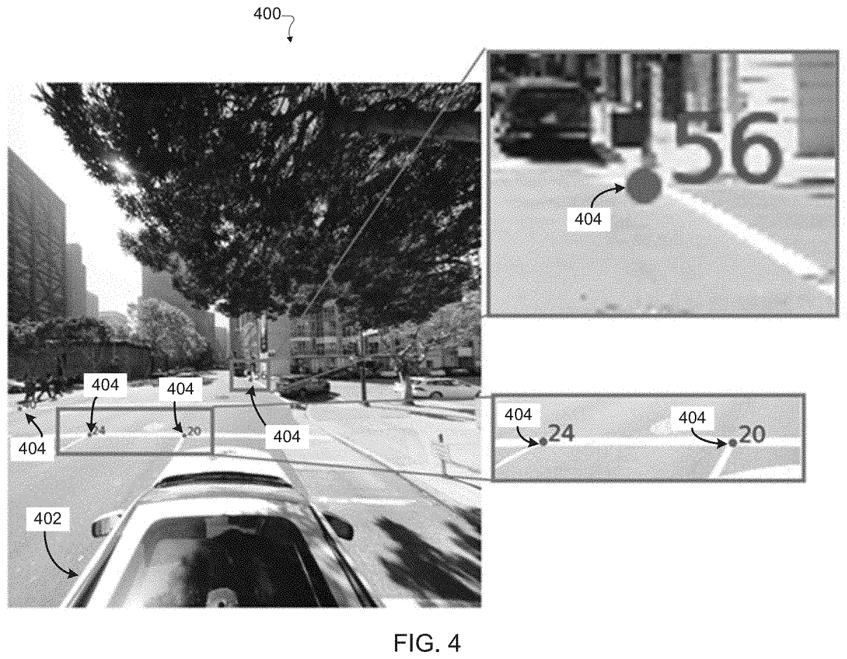

At operation 360, for each terrestrial image 315 where the tie point 325 is visible, a distance is estimated between the capture vehicle and the detected feature point, and an importance score is assigned based on the distance. For example, FIG. 4 illustrates an example environment 400 in which terrestrial images are captured and feature points are detected according to this disclosure.

As shown in FIG. 4, a capture vehicle 402 with one or more cameras (e.g., the vehicle 102d of FIG. 1) moves along a road. As the capture vehicle 402 moves, the camera(s) capture images of various feature points 404 on the road. One or more of the feature points 404 may represent a tie point 325 for a terrestrial image 315. The number shown next to each feature point 404 in FIG. 4 indicates the estimated distance (in meters) from the capture vehicle 402 to the feature point 404. In some embodiments, a monocular depth estimation procedure can be used to estimate the distance of the feature points 404. There are multiple depth estimation algorithms available, and this disclosure encompasses any suitable one.

Multiple images can be captured at different times, and sometimes from different angles, as the capture vehicle 402 moves. In some embodiments, one or more of the same feature points 404 might also be captured in another image by another camera on a different vehicle during a different drive. These different images might be grouped into one object 310. The same feature point 404 can receive different scores in different images since the feature point 404 can be at different distances or captured with different cameras having different accuracies or resolutions. In general, closer feature points 404 are considered more important since triangulation is more accurate in the near field. The different scores can be aggregated (e.g., by summing, averaging, or another suitable method) to determine an overall score for the feature point 404.

At operation 365, for each terrestrial image 315 where the tie point 325 is visible, a “GPS quality” of the capture associated with the terrestrial image 315 is estimated, and an importance score is assigned based on the GPS quality. As used herein, GPS quality refers to a relative accuracy of the terrestrial capture, which can be, e.g., related to error in position of the camera. Typically, the GPS quality is use case dependent. For example, if the terrestrial source is to be used as a control for top-down images, then the GPS quality (and thus the importance score) can increase with increasing accuracy. Conversely, if the terrestrial source is to be controlled by top-down imagery, then the GPS quality (and the importance score) can decrease with increasing accuracy. Thus, GPS quality can be used to prioritize “good” terrestrial captures for use as a control for top-down sources, or “bad” terrestrial captures which require control from top-down sources.

As indicated above, the importance score of each stray point 330 in the object 310 can be determined at operation 345. The importance score of a stray point 330 can be determined by estimating the importance of the image 315, 320 where the stray point 330 is detected, in operation 370, and assigning an importance score to the stray point 330 based on the importance of the image 315, 320. In some embodiments, the importance of the image 315, 320 can be indicated by a constant value, such as by simply adding up the number of stray points 330 in the image 315, 320. In some embodiments, the importance of the image 315, 320 can be a function of image metadata, e.g., a higher resolution image results in a higher importance score. Inherently, the determination of the importance score of each stray point 330 is simpler than determining the importance score of each tie point 325 because each stray point 330 is only in one image and is not tied to any other image.

For each object 310 that is obtained in operation 305, an importance score can be determined using the process 300. Later, the importance scores of the objects 310 can be used deterministically to rank the objects 310 by importance and select the highest importance objects 310 for manual review. By determining the highest importance objects 310 for manual review, the expensive manual review process is optimized. Stated differently, the process 300 allows humans to review images that have automatically prioritized based on better accuracy and better features.

In some embodiments, the importance scores of the objects 310 can be used in combination with other object metadata (such as the geographical distribution of the image collections) in a deterministic or random sampling procedure. A random sampling might be used when the highest importance objects 310 are geographically grouped in a small area, but the objects 310 would be more useful if the selected objects 310 were spread further apart geographically. One example of a random sampling procedure is a Determinantal Point Process (DPP) with a geographic distance kernel that emphasizes collections with a specified distance between samples. In this case, K is the square matrix, and the sampling kernel entry for objects {i,j} would be adjusted from Kᵢⱼ to qᵢqⱼKᵢⱼ, where qᵢ is the importance of object i. In this way, collections of objects with large pairwise distances (as reflected in Kᵢⱼ) or large importances (as reflected in qᵢqⱼ) would be preferred (and close objects would be disfavored) when sampling objects for human review.

Although FIG. 3 illustrates an example process 300 for estimating the importance of collections of top-down and terrestrial images, various changes may be made to FIG. 3. For example, various operations in FIG. 3 may overlap, occur in parallel, occur in a different order, or occur any number of times. Also, one or more operations could be added to the process 300, and one or more operations could be removed from the process 300.

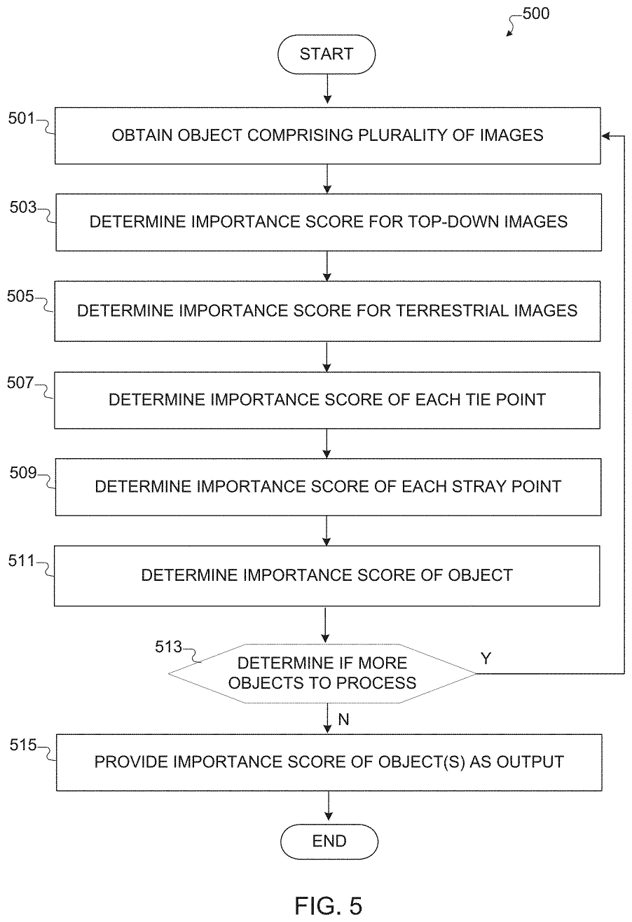

FIG. 5 illustrates an example method 500 for importance ranking for collections of top-down and terrestrial images according to this disclosure. For ease of explanation, the method 500 may be described as using the process 300 of FIG. 3, and may involve the use of one or more components of FIG. 1 or FIG. 2. For example, some of operations of FIG. 5 may be performed by the server 106. However, the method 500 may involve the use of any suitable device(s) in any suitable environment(s).

At step 501, an object comprising a plurality of images is obtained. Each image includes one or more tie points, one or more stray points, or a combination of these. In some embodiments, a first subset of the images are top-down images generated using at least one satellite-based or aerial vehicle-based camera, and a second subset of the images are terrestrial images generated using at least one terrestrial camera. This can include, for example, the server 106 obtaining an object 310 using operation 305. The object 310 can include one or more terrestrial images 315 and one or more top-down images 320. Each image 315, 320 can include one or more tie points 325 and/or stray points 330.

At step 503, an importance score is determined for the top-down images in which a particular tie point is visible. In some embodiments, the importance score can be determined based on metadata associated with each of the top-down images. This can include, for example, the server 106 determining the importance score for the top-down images 320 using operation 350.

At step 505, an importance score is determined for the terrestrial images in which the particular tie point is visible. In some embodiments, the importance score can be determined by, for each of the terrestrial images, estimating a distance from a camera to the tie point at a time that the terrestrial image was captured, determining a distance importance score based on the estimated distance, estimating a GPS quality of the terrestrial image, determining a quality importance score based on the estimated GPS quality, and aggregating the distance importance scores and the quality importance scores to obtain the importance score for the terrestrial images. This can include, for example, the server 106 determining the importance score for the terrestrial images 315 using operations 355, 360, and 365.

At step 507, an importance score of the particular tie point is determined by aggregating the importance score for the top-down images (as determined in step 503) and the importance score for the terrestrial images (as determined in step 505). This can include, for example, the server 106 determining the importance score of the tie point 325 using operation 340.

At step 509, an importance score of each stray point in the images is determined. In some embodiments, the importance score is determined by determining an importance score of each of the plurality of images in which the stray point is visible, and aggregating the determined importance scores of the images that include the stray point. This can include, for example, the server 106 determining the importance of each stray point 330 using operations 345 and 370.

At step 511, an importance score of the object is determined based on the importance score of the one or more tie points and the importance score of the one or more stray points. In some embodiments, the importance score of the object is determined by aggregating the importance scores of all of the tie points and all of the stray points included in the object. This can include, for example, the server 106 determining the importance score of the object 310 using operation 335.

At step 513, it is determined if there are any more objects to process. This can include, for example, the server 106 querying the database 108 for objects to process. If it is determined that there are additional objects to process, the method 500 returns to step 501. If it is determined that there are no more objects to process, the method proceeds to step 515.

At step 515, the importance score(s) of the processed object(s) are provided as an output for selection of the object(s) for image labeling. In some embodiments, when there are multiple objects that have been processed, a subset of the objects is selected using a determinantal point process and the importance scores of the objects. This can include, for example, the server 106 providing a list of objects 310 with highest importance for manual review.

Although FIG. 5 illustrates one example of a method 500 for importance ranking for collections of top-down and terrestrial images, various changes may be made to FIG. 5. For example, while shown as a series of steps, various steps in FIG. 5 may overlap, occur in parallel, occur in a different order, or occur any number of times. Also, one or more steps could be added to the method 500, and one or more steps could be removed from the method 500.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method comprising:
obtaining an object comprising a plurality of images, each image comprising at least one of: one or more tie points or one or more stray points;
determining an importance score of each tie point of the one or more tie points in the images;
determining an importance score of each stray point of the one or more stray points in the images;
determining an importance score of the object based on the importance score of the one or more tie points and the importance score of the one or more stray points; and
providing the importance score of the object as an output for selection of the object for image labeling.

2. The method of claim 1, wherein:
a first subset of the images are top-down images generated using at least one satellite-based or aerial vehicle-based camera, and a second subset of the images are terrestrial images generated using at least one terrestrial camera; and
determining the importance score of each tie point of the one or more tie points in the images comprises:
determining an importance score for the top-down images in which the tie point is visible;
determining an importance score for the terrestrial images in which the tie point is visible; and
aggregating the importance score for the top-down images and the importance score for the terrestrial images.

3. The method of claim 2, wherein determining the importance score for the top-down images in which the tie point is visible comprises:
determining the importance score based on metadata associated with each of the top-down images.

4. The method of claim 2, wherein determining the importance score for the terrestrial images in which the tie point is visible comprises:
for each of the terrestrial images:
estimating a distance from a camera to the tie point at a time that the terrestrial image was captured and determining a distance importance score based on the estimated distance, and
estimating a GPS quality of the terrestrial image and determining a quality importance score based on the estimated GPS quality; and
aggregating the distance importance scores and the quality importance scores to obtain the importance score for the terrestrial images.

5. The method of claim 1, wherein determining the importance score of each stray point of the one or more stray points in the images comprises:
determining an importance score of each of the plurality of images in which the stray point is visible; and
aggregating the determined importance scores of the images that include the stray point.

6. The method of claim 1, wherein determining the importance score of the object based on the importance scores of the one or more tie points and the importance scores of the one or more stray points comprises:
aggregating the importance scores of all of the tie points and all of the stray points included in the object.

7. The method of claim 1, wherein:
the object is one of multiple objects;
determining the importance score of the object comprises determining the importance score for each of the multiple objects; and
the method further comprises:
selecting a subset of the multiple objects using a determinantal point process and the importance scores of the multiple objects.

8. A system comprising:
at least one memory configured to store instructions; and
at least one processor coupled to the at least one memory and configured when executing the instructions to:
obtain an object comprising a plurality of images, each image comprising at least one of: one or more tie points or one or more stray points;
determine an importance score of each tie point of the one or more tie points in the images;
determine an importance score of each stray point of the one or more stray points in the images;
determine an importance score of the object based on the importance score of the one or more tie points and the importance score of the one or more stray points; and
provide the importance score of the object as an output for selection of the object for image labeling.

9. The system of claim 8, wherein:
a first subset of the images are top-down images generated using at least one satellite-based or aerial vehicle-based camera, and a second subset of the images are terrestrial images generated using at least one terrestrial camera; and
to determine the importance score of each tie point of the one or more tie points in the images, the at least one processor is configured to:
determine an importance score for the top-down images in which the tie point is visible;
determine an importance score for the terrestrial images in which the tie point is visible; and
aggregate the importance score for the top-down images and the importance score for the terrestrial images.

10. The system of claim 9, wherein to determine the importance score for the top-down images in which the tie point is visible, the at least one processor is configured to:
determine the importance score based on metadata associated with each of the top-down images.

11. The system of claim 9, wherein to determine the importance score for the terrestrial images in which the tie point is visible, the at least one processor is configured to:
for each of the terrestrial images:
estimate a distance from a camera to the tie point at a time that the terrestrial image was captured and determining a distance importance score based on the estimated distance, and
estimate a GPS quality of the terrestrial image and determining a quality importance score based on the estimated GPS quality; and
aggregate the distance importance scores and the quality importance scores to obtain the importance score for the terrestrial images.

12. The system of claim 8, wherein to determine the importance score of each stray point of the one or more stray points in the images, the at least one processor is configured to:
determine an importance score of each of the plurality of images in which the stray point is visible; and
aggregate the determined importance scores of the images that include the stray point.

13. The system of claim 8, wherein to determine the importance score of the object based on the importance scores of the one or more tie points and the importance scores of the one or more stray points, the at least one processor is configured to:
aggregate the importance scores of all of the tie points and all of the stray points included in the object.

14. The system of claim 8, wherein:
the object is one of multiple objects;
to determine the importance score of the object, the at least one processor is configured to determine the importance score for each of the multiple objects; and
the at least one processor is further configured to select a subset of the multiple objects using a determinantal point process and the importance scores of the multiple objects.

15. A non-transitory computer readable medium containing instructions that when executed cause at least one processor to:
obtain an object comprising a plurality of images, each image comprising at least one of: one or more tie points or one or more stray points;
determine an importance score of each tie point of the one or more tie points in the images;
determine an importance score of each stray point of the one or more stray points in the images;
determine an importance score of the object based on the importance score of the one or more tie points and the importance score of the one or more stray points; and
provide the importance score of the object as an output for selection of the object for image labeling.

16. The non-transitory computer readable medium of claim 15, wherein:
a first subset of the images are top-down images generated using at least one satellite-based or aerial vehicle-based camera, and a second subset of the images are terrestrial images generated using at least one terrestrial camera; and
the instructions to determine the importance score of each tie point of the one or more tie points in the images comprise instructions to:
determine an importance score for the top-down images in which the tie point is visible;
determine an importance score for the terrestrial images in which the tie point is visible; and
aggregate the importance score for the top-down images and the importance score for the terrestrial images.

17. The non-transitory computer readable medium of claim 16, wherein the instructions to determine the importance score for the top-down images in which the tie point is visible comprise instructions to:
determine the importance score based on metadata associated with each of the top-down images.

18. The non-transitory computer readable medium of claim 16, wherein the instructions to determine the importance score for the terrestrial images in which the tie point is visible comprise instructions to:
for each of the terrestrial images:
estimate a distance from a camera to the tie point at a time that the terrestrial image was captured and determining a distance importance score based on the estimated distance, and
estimate a GPS quality of the terrestrial image and determining a quality importance score based on the estimated GPS quality; and
aggregate the distance importance scores and the quality importance scores to obtain the importance score for the terrestrial images.

19. The non-transitory computer readable medium of claim 15, wherein the instructions to determine the importance score of each stray point of the one or more stray points in the images comprise instructions to:
determine an importance score of each of the plurality of images in which the stray point is visible; and
aggregate the determined importance scores of the images that include the stray point.

20. The non-transitory computer readable medium of claim 15, wherein the instructions to determine the importance score of the object based on the importance scores of the one or more tie points and the importance scores of the one or more stray points comprise instructions to:
aggregate the importance scores of all of the tie points and all of the stray points included in the object.
